(19) United States
(12) Patent Application Publication
(10) Pub. No.: US 2021/0033556 A1
(43) Pub. Date: Feb. 4, 2021

(54) SENSOR FOR DETERMINING GAS PARAMETERS

(71) Applicant: Heraeus Nexensos GmbH, Hanau (DE)

(72) Inventors: Matthias Muziol, Mainhausen (DE); Tim Asmus, Allendorf-Winnen (DE); Stefan Dietmann, Alzenau (DE)

(73) Assignee: Heraeus Nexensos GmbH, Hanau (DE)

(21) Appl. No.: 16/613,928

(22) PCT Filed: May 3, 2018
(86) PCT No.: PCT/EP2018/061273

§ 371 Date: Nov. 15, 2019

(30) Foreign Application Priority Data
May 18, 2017 (EP) 17171650.9

(51) Int. Cl. G01N 27/14; B32B 18/00; H01B 1/04; C04B 35/58; C04B 35/584; C04B 35/515; G01M 15/10; H01B 3/12; G01N 15/06; C04B 35/581

(52) U.S. Cl. CPC G01N 27/14; C04B 2235/442; H01B 1/04; C04B 35/58085; C04B 35/584; C04B 35/515; G01M 15/102; H01B 3/12; G01N 15/0656; C04B 35/581; C04B 2235/3865; C04B 2235/3891; B32B 2457/00; C04B 2235/3873; B32B 2307/304; B32B 18/00

(57) ABSTRACT

A high-temperature sensor, having at least one completely ceramic heater and at least one first sensor structure arranged on a first side of the completely ceramic heater, at least in areas. And a method for producing a sensor.

The present invention relates to a sensor for determining gas parameters according to independent claim 1. The present invention also relates to a method for producing a sensor.

The most varied of sensors for analyzing gases are known from the prior art. Such sensors are often used in the exhaust gas system of internal combustion engines, for example as temperature sensors, soot sensors, flow sensors, and as multi-sensors, which may comprise a combination of different sensor types. The combustion gases or exhaust gases of such internal combustion engines may have a very high temperature depending on the position of the sensor in the exhaust gas system relative to the engine. Thus, very high temperature gradients may frequently occur accordingly, which can negatively influence the function of the sensor, during cooling of the sensor. Depending on usage, these sensors must be actively brought to a certain temperature level, permanently or at certain time intervals, for pyrolytic cleaning in order to ensure the functionality. Thus, the sensors must have high temperature-shock resistance, i.e. high resistance to strong temperature changes. For example, such temperature changes can result from impact with drops of condensate.

An example of a sensor that can be used in the exhaust system of an internal combustion engine is described in WO 2007/048573 A1. The sensor comprises a velocity sensor element with a temperature measurement element and a heating element. These elements are arranged on a support element, wherein the temperature measurement element has a platinum thin-film resistor on a ceramic substrate for temperature measurement and is heated with an additional platinum thin-film resistor.

An example of a soot sensor with heating element is shown in WO 2006/111386 A1. The described soot sensor has a sensor structure on a substrate for determining soot deposit. In order to burn off soot, a heating conductor is arranged on the substrate as a thin-film structure made of platinum.

However, the sensors known from the prior art have the disadvantage that the sensor structures and heating elements take up a large surface on the substrate. In addition, the production costs of the sensors known from the prior art are correspondingly high due to the precious metal content in the low-resistance heating elements. A further disadvantage of the heating elements known from the prior art is the low temperature-shock resistance. This low resistance to quick temperature changes often is expressed in cracks and/or other changes in the substrate material.

Thus, the object of the present invention is to provide an improved sensor that overcomes the disadvantages of the prior art. In particular, the object is to provide a sensor resistant to high temperatures that is economical to produce.

According to the invention, this object is achieved by means of the subject matter of claim 1.

To this end, the sensor according to the invention, particularly the high-temperature sensor, has the following:

at least one completely ceramic heater; and
at least one first sensor structure arranged on a first side of the completely ceramic heater, at least in areas.

The term “completely ceramic heater” can be understood to be a heater comprising a heating conductor made of an electrically conductive ceramic and a shell made of an electrically insulating ceramic. The electrically conductive ceramic and the electrically insulating ceramic can be sintered into a homogenous body.

Preferably, the areas of the electrically conductive ceramic and the electrically insulating ceramic are joined together as a green body and the completely ceramic heater is produced by means of co-sintering, i.e. in a common sintering step. Therefore, in examples of the invention, the completely ceramic heater can also be characterized as a “co-sintered completely ceramic heater.”

In terms of the present invention, any structure that is adapted to record at least one gas parameter of a gas flowing passed can be considered a “sensor structure.”

The surprising finding with the present invention is that a sensor with a reduced precious metal content can be produced, because the completely ceramic heater is substantially constructed without precious metal components. Electrodes, for example electrical feed lines which may comprise the precious metal components, can be used only for making contact with the ceramic. In examples of the invention, the electrodes may be further advantageously also formed by means of an electrically conductive ceramic, which substantially comprises no precious metal components.

Due to the invention, it has been successful for the first time to obtain a sensor for high-temperature changes which can withstand high temperatures over 1000° C. as well as quick temperature changes without this resulting in destruction or in a drift, i.e. changes in an output signal of the sensor without it resulting in changes in the variable to be measured.

Compared to the sensors known from the prior art which have a similar size, the sensor further advantageously offers more space for the sensor structure(s), because, with the sensor according to the invention, heating on a surface of a support element or substrate which is arranged about or in the sensor structure is not absolutely necessary.

In addition, a long service life of the heater is ensured due to the good aging and wear resistance of the ceramics. Temperatures of up to 1000° C. can be reliably recorded with a completely ceramic heater constructed in this manner. Further advantages of the completely ceramic heater are short heat-up times, low residual heat, improved controllability, increased service life at high temperatures, as well as high mechanical strength.

A further advantage of the sensor on a completely ceramic heater is the possibility of use in electrically conductive media such as, e.g., fluids or ionized gases. Due to the electrically insulating shell of the completely ceramic heater, there is no risk of a short-circuit, contrary to the exposed heaters.

In one example, the completely ceramic heater has at least one electrically conductive ceramic; preferably, the electrically conductive ceramic makes contact with electrodes in at least two positions separate from one another. Furthermore, the completely ceramic heater has at least one electrically insulating ceramic, wherein the electrically insulating ceramic encloses the electrically conductive ceramic, at least in areas, preferably enclosing it completely.

The electrically conductive ceramic can also be characterized as a heating conductor or heating resistor. The task of the electrically conductive ceramic is to convert electrical energy into thermal energy. To this end, the electrically conductive ceramic preferably has a low specific resistance, for example in a range of from 5*10⁻³ Ω cm to 5*10⁻¹ Ω cm, so that the ceramic heats up when current flows through it. The resistance of the heating conductor can be specified by means of the spatial arrangement of the electrodes on the ceramic and is formed by means of the resistance section between the electrodes.

In this context, the term “electrode” can be used to characterize an electrical conductor or an area, for example a connection pad, of an electrical conductor which is electrically connected to the electrically conductive ceramic.

According to the invention, the electrically conductive ceramic is surrounded by the electrically insulating ceramic, at least in areas. In one example, the electrically conductive ceramic can be encapsulated in the electrically insulating ceramic, or even hermetically sealed. The surface of the completely ceramic heater can thus be formed by means of the electrically insulating ceramic, and the first sensor structure can be arranged on the electrically insulating ceramic.

The electrodes can be guided through the electrically insulating ceramic such that the completely ceramic heater can be electrically contacted; for example, the completely ceramic heater can be connected to a power supply source by means of the electrodes. For example, the electrodes can be metal wires.

The completely ceramic heater can be formed, for example, by means of pressing at least one ceramic powder into a desired form as a so-called “green body.” Depending on the desired purpose of use however, other forming processes, such as tape casting, extruding, injection molding, and high-pressure slip casting, etc., can be used to produce the green body. After production of the green body, the green body can be sintered in a nitrogen atmosphere. A possible production method is described, for example, in EP 0 384 342 A1.

Furthermore, the electrically insulating or electrically conductive ceramic may comprise a mixture of two powders and more in order to thus better specify, for example, the mechanical properties of the ceramics.

Depending on the intended area of use of the resulting sensor, the quantity ratios of the powders can be changed relative to one another such that the ceramics may have different electrical and/or thermal properties depending on the powder quantities.

The powders can also be homogenously mixed such that the material properties of the ceramics are substantially equivalent over the entire expansion of the ceramics. Alternatively, the ceramics may also have nonuniformly mixed powder in certain areas in order to hereby have better/worse electrical and/or thermal conductivities in these areas, depending on the intended area of use of the resulting sensor.

In one example, the electrically conductive ceramic is formed from ceramic powders comprising silicide, carbonate, and/or nitride powder, and at least one element from the tungsten, tantalum, niobium, titanium, molybdenum, zirconium, hafnium, vanadium, and/or chromium group, and the electrically insulating ceramic is formed from heat-conducting ceramic powders comprising silicon nitride and/or aluminum nitride.

Advantageously, the elements of the ceramic powders of the electrically conductive ceramic mean that the electrically conducting ceramic has a low specific resistance. Further advantageously, the elements of the ceramic powders of the electrically insulating ceramic mean that the electrically insulating ceramic has a high strength value as well as high oxygen resistance.

In another example, the completely ceramic heater has a thickness between 0.3 mm and 3 mm; preferably, the completely ceramic heater has a thickness between 0.5 mm and 1.5 mm.

Advantageously, extremely thin completely ceramic heaters can be realized on which the first sensor structure can be arranged and which can provide sufficient heating capacity for heating the first sensor structure.

In yet another example, the sensor has the following:

at least one first insulating layer arranged on the first side of the completely ceramic heater, at least in areas and/or
at least one second insulating layer arranged, at least in areas, on a second side of the completely ceramic heater, which is opposite the first side.

Depending on the completely ceramic heater used, the first and/or second insulating layer can be arranged either on the electrically conductive ceramic or on the electrically insulating ceramic and can serve as an electrical insulator between the electrically conductive ceramic and the sensor structure(s). Further advantageously, the first and/or second insulating layer may also serve as a bonding agent for the sensor structure(s).

In yet another example, the first insulating layer and/or the second insulating layer comprises an electrically insulating ceramic.

The electrically insulating ceramic may have good heat-conducting properties so that the heat generated by the electrically insulating ceramic can be guided through. In one example, the second insulating layer may comprise the same material as the first insulating layer. However, the second insulating layer may also have an electrically insulating ceramic with other insulating and/or heat-conducting properties as compared to those of the first insulating layer.

In one example, the first sensor structure and/or a second sensor structure, which is arranged on the first side or on a second side of the completely ceramic heater, comprises at least one resistance structure for temperature measurement, particularly a meandering measuring resistor.

The measuring resistor may be formed from a conductor with a curved path between the two electrodes. For example, the conductor may be designed with a meandering shape. Such type of measuring resistor can only be arranged on one side, either on the first or the second side of the completely ceramic heater. In another example, a measuring resistor may also be arranged on both sides of the completely ceramic heater.

Advantageously, the sensor structure(s) may extend over the entire surface of the completely ceramic heater, because no separate heating element must be arranged on the surface of the completely ceramic heater.

In another example, the first sensor structure and/or the second sensor structure, which is/are arranged on the first side or on the second side of the completely ceramic heater, comprises at least one comb structure, IDK structure, for measuring a concentration of a deposit of soot particles.

Typically, IDK structures can be used to determine soot particles in a soot sensor.

In one example, the first sensor structure and/or the second sensor structure, which is arranged on the first side or on the second side of the completely ceramic heater, comprises at least one electric heating element and at least one temperature sensor for an anemometric measurement.

Such sensor structures can be used in flow-rate sensors, which can also be characterized as flow sensors, in order to measure the flow rate in a channel, for example in an exhaust system.

In addition, different sensor structures can be arranged on both sides of the completely ceramic heater to determine different variables. Such type of sensor can be characterized as a multi-sensor.

In yet another example, the first sensor structure and/or the second sensor structure comprises at least one platinum material.

Advantageously, the sensor structure(s) may have a platinum resistor as a measuring resistor.

In another example, the sensor has the following:

at least one ceramic intermediate layer, arranged on the first sensor structure, at least in areas, and/or at least one second ceramic intermediate layer, arranged on the second sensor structure, at least in areas, wherein the first and/or second ceramic intermediate layer preferably comprises aluminum oxide and/or magnesium oxide.

Advantageously, such ceramic intermediate layers can be used as diffusion barriers, as is described, for example, in DE 10 2007 046 900 B4.

In yet another example, the sensor has the following:

at least one first covering layer arranged on the first ceramic intermediate layer, at least in areas; and/or
at least one second covering layer arranged on the second ceramic intermediate layer, at least in areas.

Such a covering layer may be arranged on the ceramic intermediate layer(s) as a passivation layer, which may contain, for example, quartz glass and optionally a ceramic, as is described, for example, in DE 10 2007 046 900 B4.

The invention also proposes a use of a sensor according to any of the preceding claims, particularly in the exhaust system of a motor vehicle, as a temperature sensor, soot sensor, flow sensor, and/or as a multi-sensor, which comprises a combination of temperature sensor, soot sensor, and/or flow sensor.

Furthermore, the invention proposes a method for producing a sensor, particularly a high-temperature sensor, having the following steps:

providing at least one completely ceramic heater; and
placing at least one first sensor structure on a first side of the completely ceramic heater, at least in areas.

Advantageously, a ceramic heater, as is described, for example, in EP 0 763 693 B1, can be used as a substrate and the sensor structure(s) can be arranged on the ceramic heater. Advantageously, the sensor can hereby be produced easily and economically.

In one example, the method is characterized in that that provision comprises:

producing the completely ceramic heater by means of co-sintering of an electrically conductive and an electrically insulating ceramic; and/or
wherein the placement comprises:
printing of the first insulating layer, especially in thin-film technology, with a platinum material.

For example, the platinum layer can also be applied to the substrate, however, in thick-film technology. To this end, platinum powder can be mixed with oxides and binders and applied to the substrate by means of screen printing. Subsequently, tempering can take place.

Further features and advantages of the invention result from the following description, in which preferred embodiments of the invention are explained by means of schematic drawings.

The following is shown:

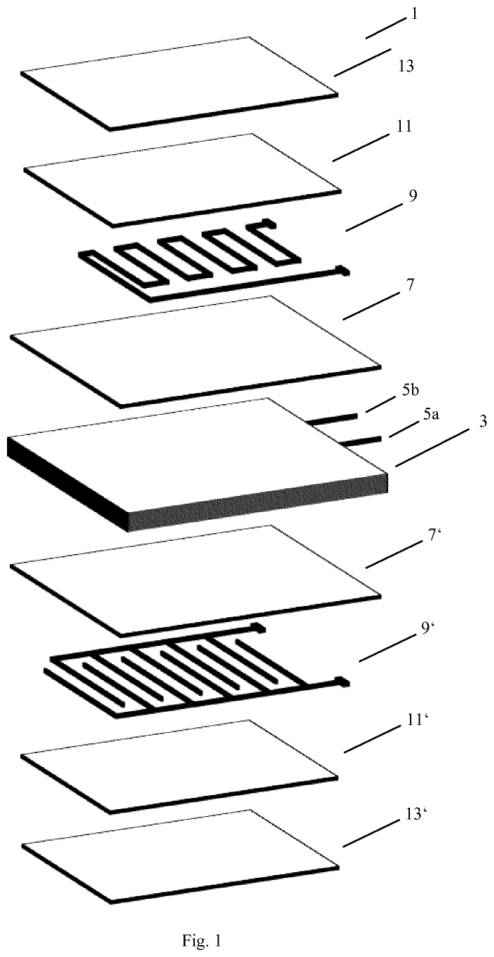

FIG. 1 a schematic exploded view of a sensor according to an embodiment of the invention;

FIG. 2 a schematic layered view of a sensor according to an embodiment of the invention;

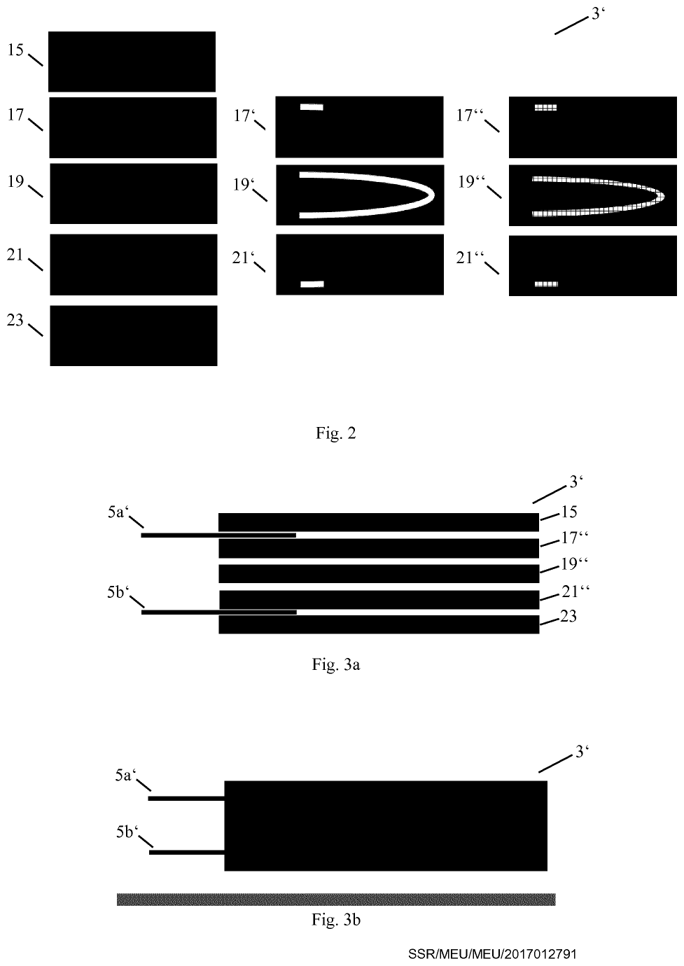

FIGS. 3a, 3b schematic views of a completely ceramic heater according to an embodiment of the invention as an exploded view and a view of the completely ceramic heater in the assembled state; and

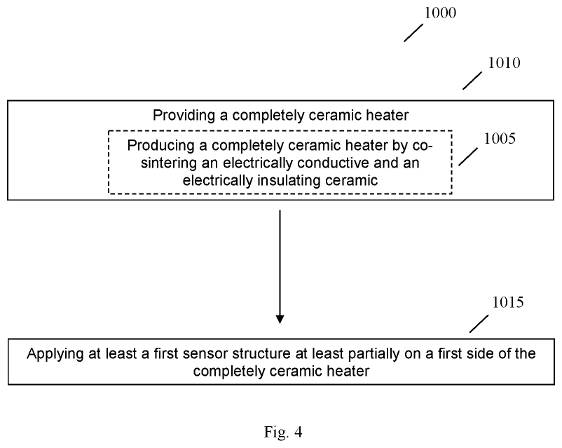

FIG. 4 a method for producing a sensor according to an embodiment of the invention.

FIG. 1 shows a schematic exploded view of a sensor 1 according to an embodiment of the invention. The sensor 1, which is shown as an example, has a completely ceramic heater 3 comprising a heating conductor made of an electrically conductive ceramic and a shell made of an electrically insulating ceramic. In the embodiment shown, the electrically conductive ceramic and the electrically insulating ceramic are sintered into a homogenous body.

Furthermore, FIG. 1 shows two electrodes 5a, 5b, which are arranged on the completely ceramic heater 3. In the embodiment shown, the electrodes 5a, 5b are designed as electrical feed lines. The electrodes 5a, 5b make contact with the electrically conductive ceramic in two different positions such that the area of the electrically conductive ceramic is formed between the electrodes 5a, 5b as a heating conductor or heating resistor. An energy source, such as a current source (not shown in FIG. 1) for example, can be connected to the electrodes 5a, 5b so that the ceramic heats up when current flows through it. The resistance of the heating conductor can be determined by means of the arrangement of the electrodes 5a, 5b on the ceramic and is formed by means of the resistance section between the electrodes 5a, 5b. In the embodiment shown in FIG. 1, the electrodes 5a, 5b are arranged next to one another on one side of the completely ceramic heater 3. One skilled in the art knows, however, that the electrodes 5a, 5b can also be arranged, in embodiments not shown, at another position of the completely ceramic heater 3, for example on opposing sides of the completely ceramic heater 3. Furthermore, in an embodiment not shown, more than two electrodes can also be arranged on the completely ceramic heater 3. For example, four electrodes can be arranged on the completely ceramic heater 3 and can make contact with the electrically conductive ceramic in order to connect two electrical circuits, which are independent of one another. In the embodiment not shown, two independently switchable heating resistors with different heat outputs can hereby be formed in one completely ceramic heater.

Optionally, in the embodiment shown in FIG. 1, a first insulating layer 7 is shown, which is arranged on the first side of the completely ceramic heater 3. For example, the first insulating layer 7 can be produced by means of screen printing an electrically insulating ceramic paste. As an alternative to this, the first insulating layer 7 can also be produced by means of coating with metal oxides using methods such as sputtering, thermal vapor deposition, or aerosol deposition. The first insulating layer 7 can completely cover a surface of the completely ceramic heater 3 or be arranged only on a partial area of the surface of the completely ceramic heater 3. In addition, in an embodiment not shown, recesses can be placed in the material of the first insulating layer in order to enable contacting of the electrodes by the first insulating layer.

A first sensor structure 9, which may be designed, for example, as a platinum resistance structure, is arranged on the completely ceramic heater 3 or on the optionally applied first insulating layer 7. The indicated first sensor structure 9 shows a meandering resistance structure as can be used, for example, for temperature measurements. The meandering resistance structure can have two terminals, as shown in FIG. 1, in order to connect the resistance structure to evaluation electronics (not shown in FIG. 1). Alternatively or in addition to the resistance structure shown, further sensor structures and/or heating elements can be arranged on the first surface of the completely ceramic heater 3, in embodiments not shown.

For example, an IDK structure can be arranged instead of or next to the meandering resistance structure to determine soot particles.

Furthermore, FIG. 1 shows, as an option merely, that the first sensor structure 9 and areas of the completely ceramic heating element 3, which are not covered by the first sensor structure 9, can be at least partially covered by a ceramic intermediate layer 11. Merely as an option, the ceramic intermediate layer 11 can, in turn, be at least partially covered by a covering layer 13. However, one skilled in the art knows that an intermediate layer 11 and/or a covering layer 13 are not necessary for use of the sensor 1 shown in FIG. 1 as a temperature sensor, soot sensor, flow sensor, and/or as a multi-sensor in the exhaust system of a motor vehicle.

In the embodiment shown in FIG. 1, a second insulating layer 7′, which may comprise a similar material as the first insulating layer 7, is arranged on the second sides of the completely ceramic heating element 3.

In the embodiment shown, an exemplary IDK structure for determining soot particles is applied as a second sensor structure 9′ on the completely ceramic heater 3. In alternative embodiments, which are not shown here, the second sensor structure 9′ may also comprise further/alternative structures, which are adapted to record one or more gas parameters of a gas flowing passed.

In addition, as has been already described herein with respect to the first side of the completely ceramic heater 3, a ceramic intermediate layer 11′ can be arranged on the second sensor structure 9′ at least in areas, wherein a covering layer 13′ can be arranged, in turn, on said intermediate layer at least an areas.

However, an arrangement of structures on the second side of the substrate 3 is not essential for the invention. A sensor 1 according to the invention may also only comprise a completely ceramic heater 3, a first insulating layer 7, and a first sensor structure 9.

FIG. 2 shows a schematic layered view of a completely ceramic heater 3′ according to an embodiment of the invention. The layered view shown in FIG. 2 may be a representation of the structure of the completely ceramic heater 3 already shown in FIG. 1.

In the left column of FIG. 2, multiple substantially similar layers 15-23 of a pressed, electrically insulating ceramic powder are shown as a so-called “green body.” As shown in FIG. 2, the layers 15-23 may have a substantially rectangular design. In embodiments not shown, the layers may also have a different geometry; for example, the layers can be round or oval.

In the middle column of FIG. 2, three layers 17′-21′ are shown, which may be the layers 17-21 shown in the left column, with recesses, which are placed, for example, by means of punching. In layers 17′ and 21′, geometries for contacting of the heating conductor with the electrodes are formed. A geometry for the heating conductor is shown in layer 19′. The geometries shown are only by example; depending on the desired purpose of use, the geometries may also be formed differently than shown; for example, the heating conductor may also be designed in the shape of a rod or meandering.

In the right column of FIG. 3, three layers 17″-21″ are shown, which may be the layers 17′-21′ shown in the middle column, with an electrically conductive ceramic powder placed in the recesses.

FIGS. 3a and 3b show schematic views of a completely ceramic heater 3′ according to an embodiment of the invention as an exploded view and a view in the assembled state.

The layers 15, 17″, 19″, 21″, and 23 shown in FIG. 2 are shown arranged on a stack in FIG. 3a. In the embodiment shown in FIG. 3a, electrodes 5a′, 5b′ are arranged in the form of contact pins or connection wires at the contacts shown in FIG. 2 for making contact with the heating conductor.

The stack shown in FIG. 3a is shown in the assembled state in FIG. 3b. For example, the layers can be connected to one another by means of sintering. For example, sintering can take place at a temperature of 1600-2000° C. in a nitrogen atmosphere.

FIG. 4 shows a method 1000 for producing a sensor 1 according to an embodiment of the invention. The method 1000 comprises the following steps:

provision 1010 of at least one completely ceramic heater 3; and
placement 1015 of at least one first sensor structure 9 on a first side of the completely ceramic heater 3, at least in areas.

Furthermore, the provision 1010 may also comprise production 1005 of the completely ceramic heater 3, 3′ by means of co-sintering an electrically conductive and an electrically insulating ceramic. FIG. 4 shows the outline of the step in a dashed line, because the production 1005 of the completely ceramic heater is merely an option.

The features shown in the previous description, in the claims, and in the figures may be essential for the invention in its various embodiments both individually and in any combination.

### LIST OF REFERENCE NUMERALS

1 Sensor
3, 3′ Completely ceramic heater
5a, 5a′, 5b, 5b′ Electrode
7, 7′ Insulating layer
9, 9′ Sensor structure
11, 11′ Ceramic intermediate layer
13, 13′ Covering layer
15 First layer
17, 17′, 17″ Second layer
19, 19′, 19″ Third layer
21, 21′, 21″ Fourth layer
23 Fifth layer
1000 Method for producing a sensor
1005 Production
1010 Provision
1015 Placement

1-15. (canceled)

16. A high-temperature sensor, comprising:
at least one completely ceramic heater; and
at least one first sensor structure arranged on a first side of the completely ceramic heater, at least in areas.

17. The sensor according to claim 16, wherein the completely ceramic heater comprises:
at least one electrically conductive ceramic; wherein the electrically conductive ceramic makes contact with electrodes in at least two positions separate from one another; and
at least one electrically insulating ceramic, wherein the electrically insulating ceramic completely encloses the electrically conductive ceramic.

18. The sensor according to claim 17, wherein the electrically conductive ceramic comprises ceramic powders comprising silicide, carbonate, and/or nitride powder, and at least one element from the tungsten, tantalum, niobium, titanium, molybdenum, zirconium, hafnium, vanadium, and/or chromium group, and in that the electrically insulating ceramic is formed from heat-conducting ceramic powders comprising silicon nitride and/or aluminum nitride.

19. The sensor according to claim 16, wherein the completely ceramic heater has a thickness between 0.5 mm and 1.5 mm.

20. The sensor according to claim 16, wherein the sensor comprises:
at least one first insulating layer arranged on the first side of the completely ceramic heater, at least in areas; and/or
at least one second insulating layer arranged, at least in areas, on a second side of the completely ceramic heater, which is opposite the first side.

21. The sensor according to claim 20, wherein the first insulating layer and/or the second insulating layer comprises an electrically insulating ceramic.

22. The sensor according to claim 16, wherein the first sensor structure and/or a second sensor structure, which is arranged on the first side or on a second side of the completely ceramic heater, comprises at least one meandering measuring resistance structure for temperature measurement.

23. The sensor according to claim 16, wherein the first sensor structure and/or a second sensor structure, which is arranged on the first side or on a second side of the completely ceramic heater, comprises at least one comb structure, IDK structure, for measuring a concentration of a deposit of soot particles.

24. The sensor according to claim 16, wherein the first sensor structure and/or a second sensor structure, which is arranged on the first side or on a second side of the completely ceramic heater, comprises at least one electric heating element and at least one temperature sensor for an anemometric measurement.

25. The sensor according to claim 16, wherein the first sensor structure and/or a second sensor structure comprises at least one platinum material.

26. The sensor according to claim 16, wherein the sensor comprises:
at least one first ceramic intermediate layer arranged on the first sensor structure, at least in areas; and/or
at least one second ceramic intermediate layer, arranged on a second sensor structure, at least in areas, wherein the first and/or second ceramic intermediate layer comprises aluminum oxide and/or magnesium oxide.

27. The sensor according to claim 26, wherein the sensor comprises:
at least one first covering layer arranged on the first ceramic intermediate layer, at least in areas; and/or
at least one second covering layer arranged on the second ceramic intermediate layer, at least in areas.

28. A use of a sensor according to claim 16, in the exhaust system of a motor vehicle, as a temperature sensor, soot sensor, flow sensor, and/or as a multi-sensor, which comprises a combination of temperature sensor, soot sensor, and/or flow sensor.

29. A method for producing a high-temperature sensor, comprising:
providing at least one completely ceramic heater; and
placing at least one first sensor structure on a first side of the completely ceramic heater, at least in areas.

30. The method according to claim 29, wherein the providing further comprises:
producing of the completely ceramic heater by means of co-sintering of an electrically conductive and an electrically insulating ceramic; and/or
wherein the placement comprises:
printing of the first insulating layer, especially in thin-film technology, with a platinum material.
